(19) United States
(12) Patent Application Publication
(10) Pub. No.: US 2005/0046213 A1
(43) Pub. Date: Mar. 3, 2005

(54) Gripper mechanism for conveying an object

(75) Inventor: Alberto Geddo, Toronto (CA)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Ontario Power Generation, Inc.

(21) Appl. No.: 10/654,140

(22) Filed: Sep. 3, 2003

(51) Int. Cl. B25J 15/10

(52) U.S. Cl. 294/95

(57) ABSTRACT

A gripper mechanism for conveying an object is taught. The gripper mechanism includes a housing, pivotal gripper members attached to the lower end of the housing, and elements for urging or releasably retaining the gripper members into at least one of two limit positions.

### FIELD OF THE INVENTION

The present invention relates to gripper mechanisms, and more particularly to a gripper mechanism for conveying an object.

### BACKGROUND OF THE INVENTION

Conveyance or movement of materials and objects is a process step in many manufacturing and processing systems. Most modern conveying systems involve some automation, and in some applications, complete automation. Automation of conveying systems, partial or complete, may provide a number of advantages over non-automated systems including increased production and increased process rates. In most applications, automation allows a process or step to be performed with minimal assistance of a technician or other personnel.

In conveying an object such as a container, the container to be moved is typically secured or locked, lifted by a crane or other lifting apparatus, moved to the desired location, lowered and released. Many gripper mechanisms that can be used in the conveyance of objects or materials are known in the art. Known gripper mechanisms use magnets, gripper arms/claws or electronic, hydraulic, pneumatic or other powered systems.

U.S. Pat. No. 4,948,187 to Blaseck teaches a crane operating lifting apparatus that uses pivotable pawls to releasably engage an object. The object to be lifted requires a coupling plate. The pawls have an outward release position which is maintained by either a spring or by the use of weighted pawls with a centre of mass outwardly offset with respect to the pivot axis. Thus, in the resting position the pawls are in outward or released position. The pawls lockably engage the coupling plate of an object by lowering a driving member within the apparatus until the driving member is seated on the object. The driving member pushes the pawls inward into a locked position, fitting closely against the chamfer of the pawls. To release the object, a driving member is required to allow the pawls to return to their resting position. The driving member is typically moved using a pull hook of a crane.

U.S. Pat. No. 4,447,085 issued to Schmid discloses a grapple assembly that uses L-shaped catches for gripping and releasing an object. Each catch has an associated link attached to a lever which is coupled to a centre post. Upward/downward movement of the levers provides engagement/disengagement of the catches. The catches are released by a downward force, however, these catches are rather complex, requiring two levers and three pivot points.

U.S. Pat. No. 4,279,699 issued to Kuhn discloses a combined gripper for a nuclear reactor for changing control rods, fuel elements, and blind rods. Pawls are coupled to flange which is biased by compression springs. The springs create an upward bias on the flange. When handling fuel elements, the gripper head is set down on the object to be lifted such that springs are compressed. The travel of the gripper head is stopped when the gripper casing abuts a stop surface. The pawls then engage apertures of a fuel element. The subsequent lifting operation or the resilience of springs locks the pawls in the aperture of the fuel element. The mechanism for releasing of the fuel element is not disclosed.

U.S. Pat. No. 4,244,616 issued to Buchalet discloses a tool for exchanging and transporting irradiated capsules of a nuclear reactor. In one aspect, a camis used to actuate pivotable fingers for lifting an irradiated capsule. To engage a capsule, the cam is moved to its upper position such that the fingers are in inoperative or disengaged retracted position. In this position, the operating tube and fingers can freely enter a recess in the cap of a capsule. The cam is then moved to its lower position, pushing the fingers outwardly into an operative position that engages the recess of the cap. In this position, the fingers allow an irradiated capsule to be lifted by a handling crane. An internal cam is required to release the fingers.

U.S. Pat. No. 4,236,967 issued to Batjukov et al. discloses a gripping means for fuel assemblies of nuclear reactors. The gripping means comprises a housing, a slider, and two or more jaws. A pusher and spring received in a hole maintain the jaws within slots by exerting an inward bias on the jaws in the direction of a slider. The downward motion of the slider causes the jaws to turn outwards and engage an internal groove in the head of a fuel assembly, allowing teeth to grip the fuel assembly. The downward movement of the slider disengages the jaw and releases the fuel assembly. The latches are not released by a downward force applied to the locking head.

U.S. Pat. No. 3,601,261 issued to Michot discloses a handling grab for nuclear reactor fuel elements. The grab comprises grappling claws pivoted about pins. The claws are arranged about a cam connected to an operating rod. The upward/downward movement of the cam causes the claw to assume a clasping/unclasping position. Movement of the can is achieved using an positioning arm connected to the operating rod by a ball joint. The latches are not released by a downward force applied to the locking head.

U.S. Pat. No. 3,310,337 issued to Riemenschneider discloses an automatic coupling and decoupling device for moving containers in nuclear reactors. The sample containers to be moved have a funnel like recess having a bulged section. The device comprises a pair of crossed grasping arms, a horizontal spacing spring, abutment pins, and a dampening device. The pins serve as an abutment to prevent the spring from moving the arms beyond the abutment. For coupling, the device is lowered onto a sample container, contact with the inner wall of the recess pushes the shaped lower edges of the arms inwards. Once the arms pass beyond the bulged section the spring returns the arms to their normal position. The container can now be lifted. For decoupling, the container is set down and the device is lowered further into the recess cap of the container. At the lowest section of the cap, the spacing between the arms is less than the diameter of the opening in the cap. The device can then be rapidly removed because the dampening member delays the action of the spring until the arms move beyond the bulged section. This device uses gripper arms rather than latches, requiring 5 pivot points and a dampener to release the container.

U.S. Pat. No. 4,199,183 issued to Hecker discloses an internal gripper apparatus having positive container alignment. The device is adapted for moving bottles or containers in an automated system such as a bottling facility. The device uses fingers maintained in a normally outward, upwardly inclined position by a spring to engage containers about the mouth. Insertion of the device into a container causes the fingers to move upwards, the periphery of the fingers forming a diameter smaller than the mouth of container. Once inside, the spring causes the fingers to return to their normal position and engage the mouth of the container. When removing the device, an actuator is moved to its lowermost position causing the fingers to move upwards, the periphery of the fingers forming a diameter smaller than the mouth of container, allowing the device to be withdrawn. This device requires a separate, internal actuator to release the container.

U.S. Pat. No. 3,251,623 issued to Fredholm discloses a grip device for lifting vessels or the like. The device is adapted to lift two annular rings or bodies arranged one on top of the other, and have concentric rings or apertures of the same size, in order to engage and lift the upper ring only or lift the two rings simultaneously. A control disc is used to select the mode of operation. The device comprises two pairs of pivotable grip arms that can each be operated separately. Each pair of arms is connected to a link head. Each arm has a lower hook shaped portion adapted for engaging the rings. The upward movement of the link head associated with a pair of arms causes the hooks to engage the aperture of the respective ring. The latches are not released by a downward force applied to the locking head.

U.S. Pat. No. 3,024,051 issued to Hullinger discloses a remote coupling mechanism, particularly adapted to couple a control rod of a nuclear reactor to its drive mechanism. The drive mechanism includes a pair of hooks radially biased by a spring. A sleeve is connected to the control rod for the coupling operation. The sleeve defines a series of tapered bores and shoulders of varying diameter. The hooks are caused to engage a first shoulder within the sleeve, thereby coupling the control rod to the drive mechanism. To disengage the drive mechanism, the drive mechanism is moved downwards causing the hooks to engage a locking plunger that maintains the hooks in a retracted position. The drive mechanism can then be raised beyond the first shoulder near the initial position of the drive mechanism where the plunger abuts a second shoulder which releases the plunger. Thus, this device requires a complex release mechanism and is for use with an elongate sleeve rather than a container.

In hazardous applications, such as in the conveyance or handling of hazardous material, for example radioactive material, it is desirable to minimize human exposure to the hazardous objects to be conveyed or handled. Magnetic, electronic, hydraulic, pneumatic and other powered systems are typically more prone to breakdown or failure during a conveyance operation, requiring a technician or other personnel to restore the operational status of the conveyance system and/or assist in the conveyance of the object to be moved until normal system operation is returned. Failure of the conveyance system may result in significant downtime, and the intervention by a technician or other personnel results in unnecessary human exposure to the hazardous material. In nuclear system applications, personnel may be exposed to radiation emitted by the object, for example, from a failed flux detector element of a nuclear reactor. Mechanical systems are less affected by power failures and are less prone to failure during a conveyance operation, however known mechanical systems for gripping objects are complex and typically involve the use of many components, often interacting with each other, increasing the chance of breakdown and thereby the exposure of personnel to the hazardous material.

It is thus desirable to have an improved mechanical gripper mechanism that is less prone to breakdown and which reduces the exposure of personnel to hazardous material.

### SUMMARY OF THE INVENTION

The present invention is a gripper mechanism for a coupling that uses pivotal grippers to releaseably engage a recessed groove in the coupling without the need for drive members or complex latching arms. The gripper mechanism may be used as an internal or external gripper.

In accordance with one aspect of the present invention, there is provided a gripper mechanism for conveying an object, comprising: a housing; gripper members, the gripper members being pivotably attached to and spaced about the lower end of the housing, each of the gripper members being pivotable between a first and second limit position; and biasing elements for urging the gripper members into one of the first and second limit positions.

In accordance with another aspect of the present invention, there is provided a gripper mechanism for a coupling having a recessed concentric engaging groove including a release surface, the gripper mechanism, comprising: a housing; gripper members, the gripper members being pivotably attached to and spaced about the lower end of the housing, each of the gripper members being pivotable between an engaging and released position; and biasing elements for urging the gripper members into one of the engaging and the released positions.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 is a sectional view of one embodiment of a locking head according to the present invention;

FIG. 2 is a bottom view of the locking head of FIG. 1;

FIG. 3 is a partial sectional view of a pivot;

FIG. 4 is a partial sectional view showing a receptacle;

FIG. 5 is a sectional view of a coupling with internal grooves that can be used with the locking head of FIG. 1;

FIG. 6A is a side view of a container implementing the coupling of FIG. 5;

FIG. 6B is a sectional side view of the container of FIG. 6A showing an inner basket received therein;

FIG. 6C is an upwards sectional view of the container of FIG. 6A;

FIG. 7 is a sectional view of a gripper of the locking head of FIG. 1;

FIG. 8A is a sectional view of the locking head of FIG. 1 prior to being introduced into the container of FIG. 6A-6C, with the grippers in engaging position;

FIG. 8B is a sectional view of the locking head of FIG. 1 received in the container of FIG. 6A-6C, with the grippers in engaging position;

FIG. 8C is a sectional view of the locking head of FIG. 1 received in the container of FIG. 6A-6C, with the grippers in the released position;

FIG. 8D is a sectional view of the locking head of FIG. 1 removed from the container of FIG. 6A-6C, with the grippers in the released position;

FIG. 9 is a sectional view of the locking head of FIG. 1 and the container of FIG. 6A-6C received in a containment vessel; and

FIG. 10 is a sectional view of a coupling with external grooves that can be used with a locking head implemented according to the present invention.

Similar references are used in different figures to denote similar components.

### DETAILED DESCRIPTION OF THE DRAWINGS

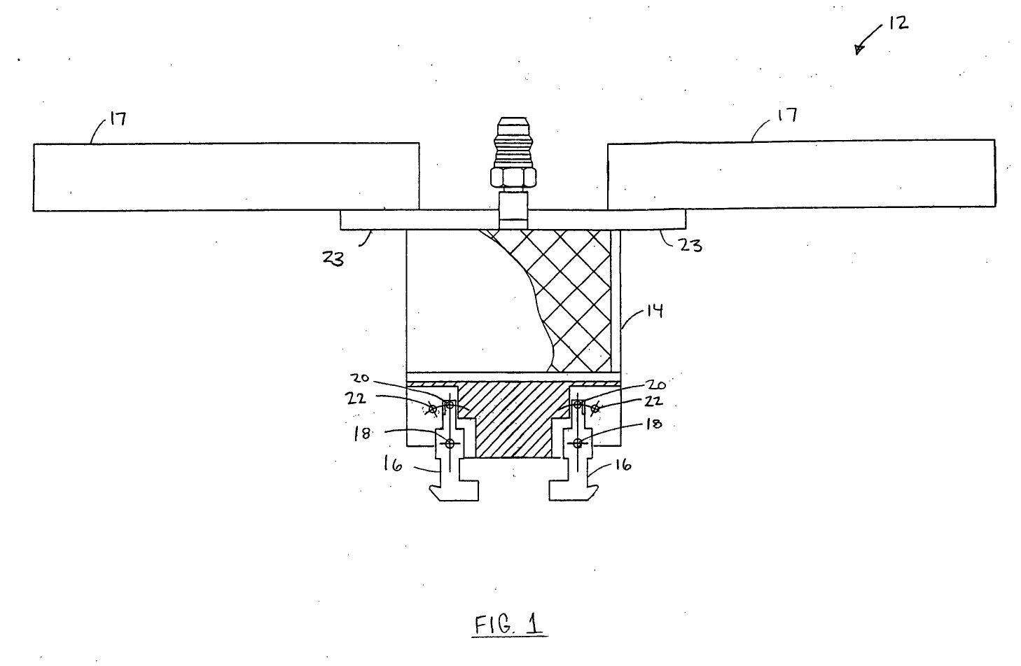

Reference is first made to FIG. 1, which shows a locking head 12 implemented according to the present invention. The locking head 12 comprises a housing 14, gripper members or grippers 16, and pull bars 17. The locking head 12 has three grippers, however a different number of grippers may be used provided at least two grippers are used. Pivots 18 provide pivotal movement of the grippers 16 between two limit positions. Biasing elements and/or gravity urge the grippers 16 into one of the two limit positions. Outer fasteners 22 engage and hold the grippers 16 in the other limit position. A stop surface 23 provides a “stop point” which may be used to prevent an operator from lowering the locking head 12 too far during the locking operation discussed below.

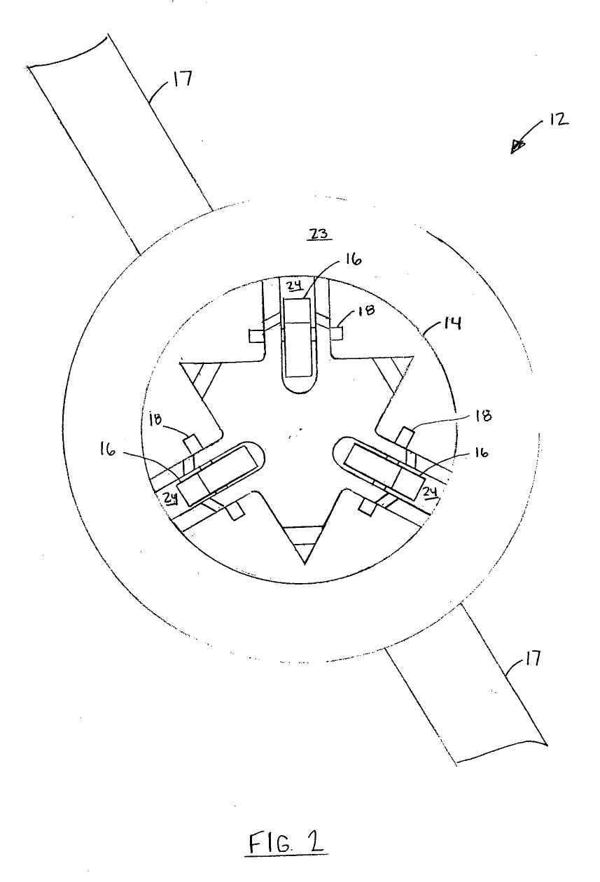

Referring now to FIGS. 1 and 2, the locking head 12 will be described in more detail. Recesses or channels 24 are defined in the lower end of the housing 14. The channels are equally spaced and adapted to receive the grippers 16. The grippers 16 are located at an angle of 120 degrees with respect to each other. In embodiments where a different number of grippers 16 are used, the grippers 16 should be equally spaced to provide balanced loading. In an alternate embodiment, only one gripper may be used.

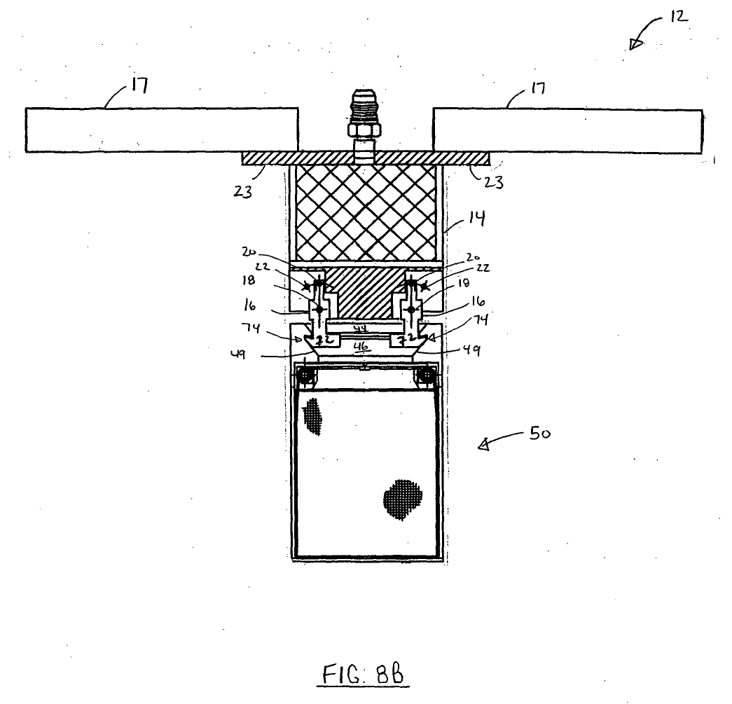

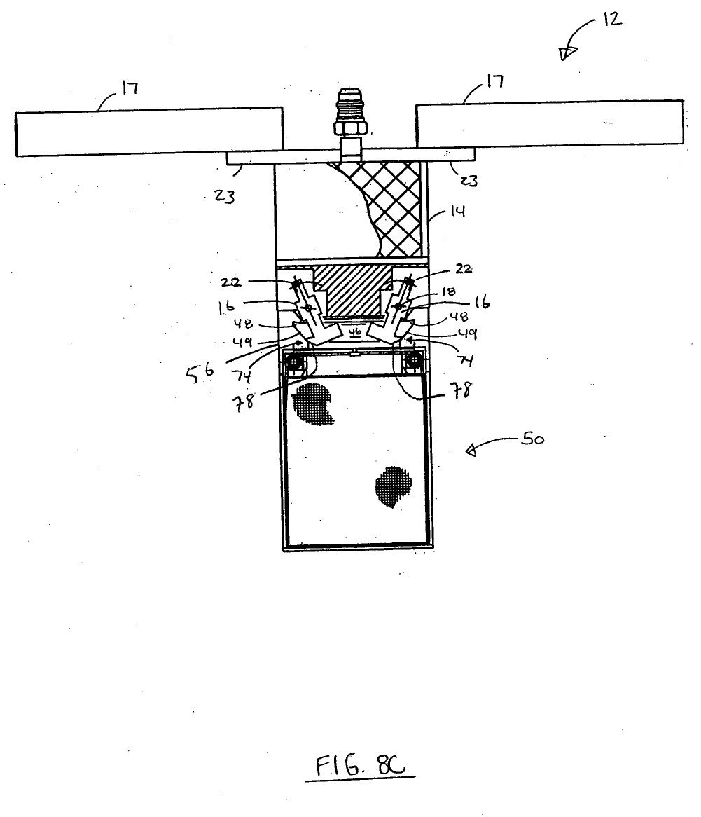

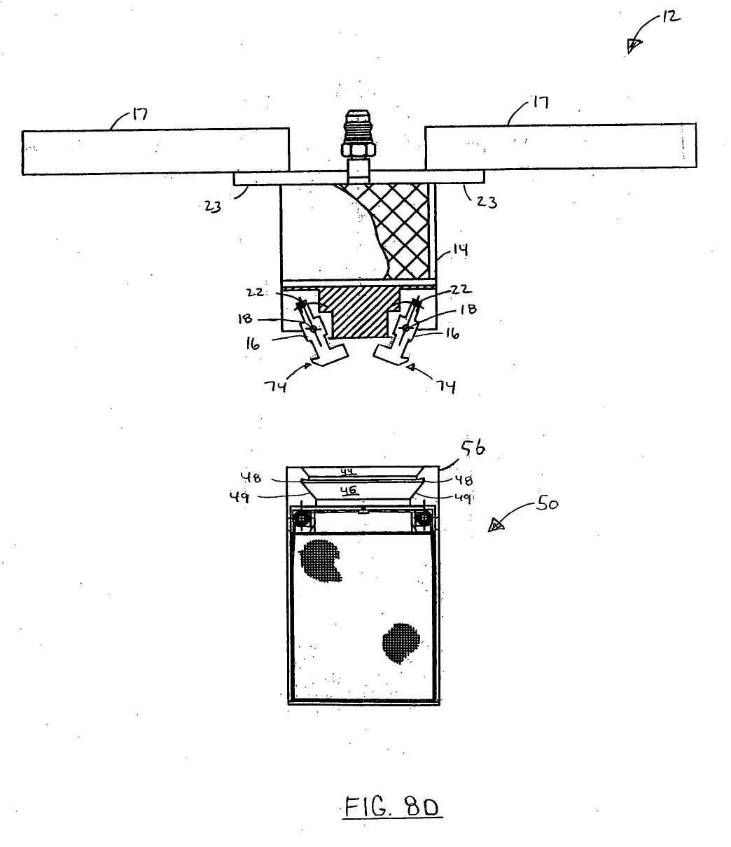

The grippers 16 are attached to the housing 14 using the pivots 18. The pivots 18 provide pivotal movement of the grippers 16 between a released and an engaging position. Gravity urges grippers 16 to the engaging position, as the bottom or gripper head end of the grippers is heavier than the top or tail end of the grippers. Optionally, in other embodiments, optional inner fasteners 20 or biasing elements (for example, a tension spring) maintain the grippers 16 in the engaging position (FIG. 1). In the engaging position, the grippers 16 are substantially vertical and are directed downwardly. Outer fasteners 22, for example ball-plungers, engage and hold the grippers 16 in the released position (FIGS. 8C and 8D) during the releasing operation discussed below. In the released position, the grippers 16 are extended inwardly and downwardly. The inner and outer fasteners may be, for example, spring tensioned beveled pins, magnets, or may operate by friction fit. Other types of inner fasteners may be used if desired.

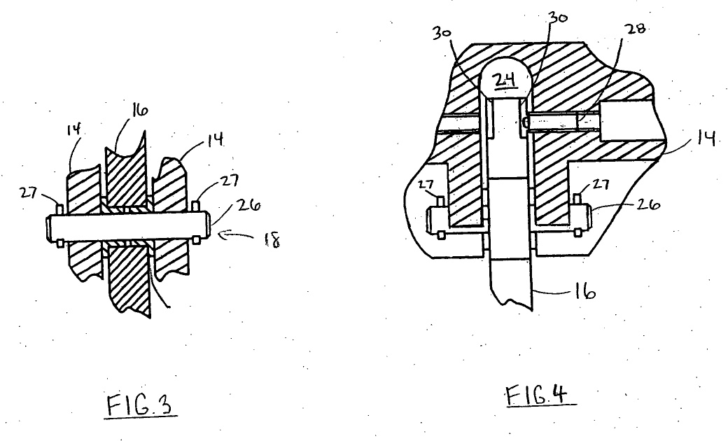

FIG. 3 shows one embodiment of the pivots 18 used in the locking head 12 wherein the pivots 18 are shafts 26 secured in corresponding pivot holes in the housing 14 and grippers 16 using cotter pins 27. The shafts 26 couple the grippers 16 to the housing 14. Clearance between the grippers 16 and the housing 14 must be sufficient so as not to impede the pivotal movement of the grippers 16. Cotter pins 27 secure the shafts 26 in their respective pivot holes. Spacers 19 or washers may be used to facilitate rotation of grippers 16 in relation to housing 14.

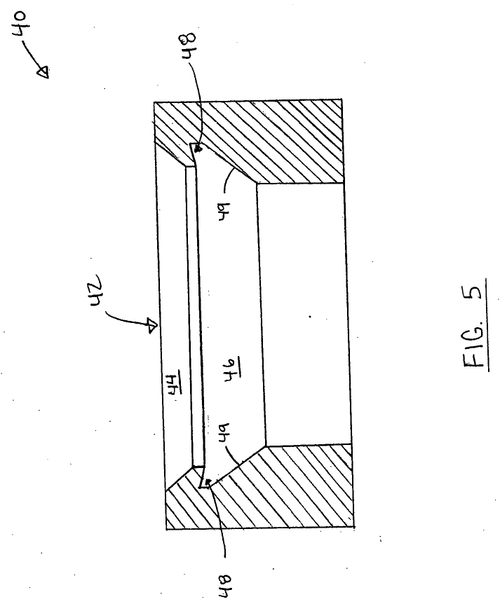

FIG. 4 shows one embodiment of the outer fasteners 22 in which the outer fasteners 22 are ball-plungers 28. The ball-plungers 28 cooperate with a corresponding detent hole 30 in the upper portion of each gripper 16. For each gripper 16, a second ball-plunger (not shown) may be used.

Referring now to FIG. 5, a coupling 40 which may be engaged by the locking head 12 will be described in more detail. The coupling 40 defines a cavity or central bore 42 of varying diameter open at its top and bottom. The coupling 40 also defines two recessed concentric grooves, a deflecting groove 44 and an engaging groove 46 having a concentric notch or chamfer 48 and a release surface 49. The grooves 44 and 46 are tapered downwardly and inwardly in the direction of the base of the coupling 40. The deflecting groove 44 deflects the grippers 16 away from the engaging position when the locking head 12 is introduced into the coupling 40. The engaging groove 46 receives and engages the grippers 16 during the locking operation discussed below.

The coupling 40 may be attached to a container or other object, or may be formed integrally with the object to be lifted, for example, as a lip or top of container such as a drum, can or jar. The coupling 40 is circular in design, but a different shape, for example square or rectangular, may also be used if desired. The number, shape and/or arrangement of the grippers 16 may have to be modified to accommodate a different shape or configuration of the coupling 40.

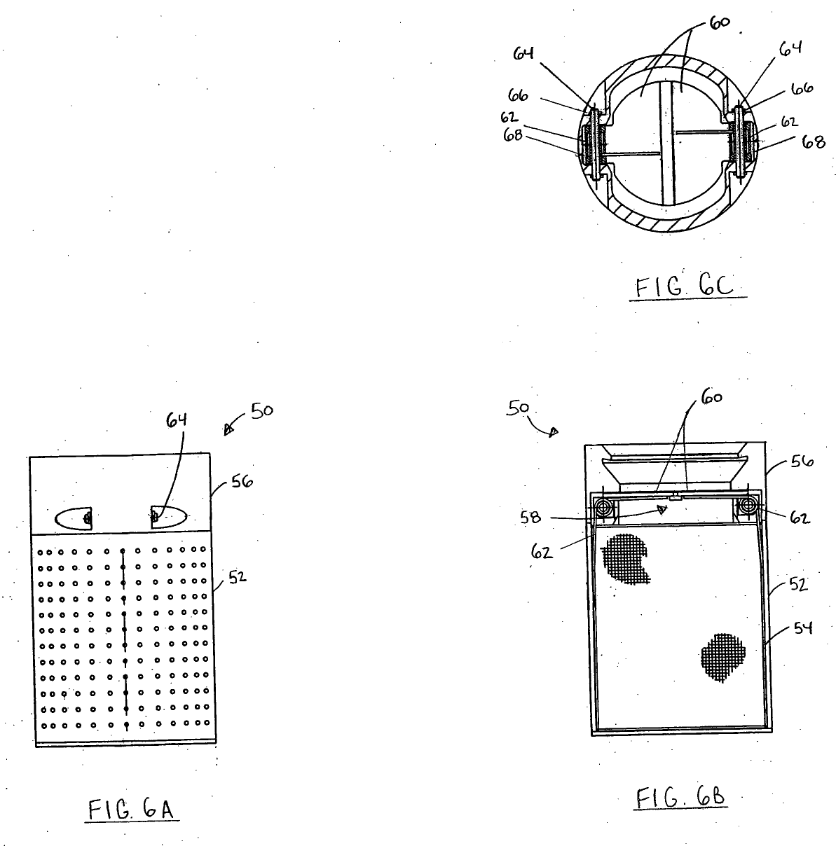

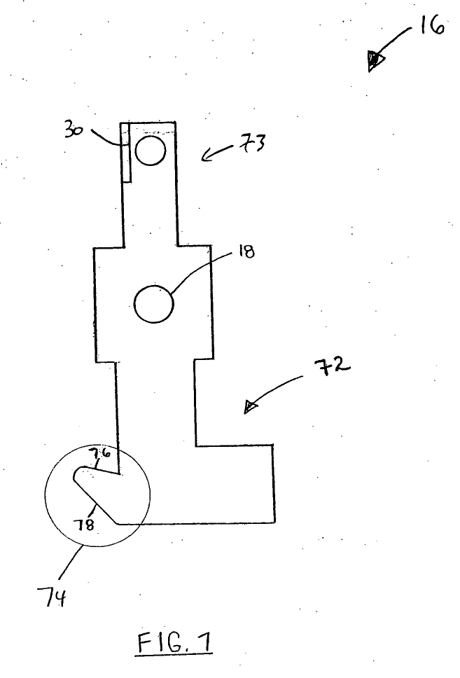

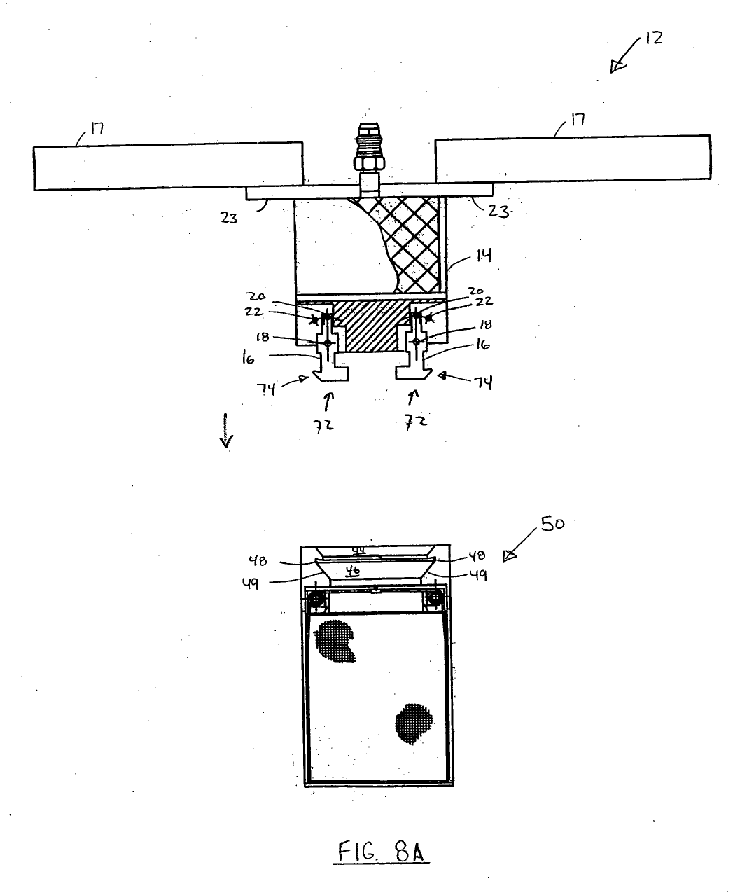

Referring now to FIG. 6A to 6C, a container 50 implementing the coupling 40 will be described. The container 50 comprises a perforated base 52, an inner basket 54, a coupling 56 and a self-closing lid 58. The self-closing lid 58 comprises a pair of mating panels 60. Each panel 60 has an upwardly biasing spring 62, a shaft 64, cotter pins 66 and a bushing 68. Each spring 62 is received in channel defined in the side of the coupling 56. Shaft 64 and pins 66 secure the spring 62 in the channel. Bushing 68 protects the portion of shaft 64 received in the channel.

Referring now to FIG. 7, the grippers 16 will be described in more detail. Each gripper 16 comprises an upper and lower portion. The upper portion of the grippers 16 is a gripper tail 73 and includes the detent holes 30. The lower portion includes a gripper head 72 having an engaging portion 74. The engaging portion 74 has upper and lower chamfers or engaging surfaces 76 and 78 respectively. The chamfers 76 and 78 and the shape of the engaging portion 74 corresponds to the shape of the engaging groove 46 such that during the locking operation, the engaging portion 74 grips or engages the groove 46 in the chamfer 48. The angle of inclination of the upper chamfer 76 of the gripper heads 72 is adapted to correspond to the chamfer 48 of the engaging groove 46. Similarly, the angle of inclination of the lower chamfer 78 is adapted to correspond to the angle of the release surface 49 of the engaging groove 46. Gripper head 72 is heavier than gripper tail 73, so that, under gravity, gripper head 72 is urged downward in relation to pivot 18.

Referring now to FIG. 8A to 8D, the operation of the present invention will explained by way of example using the container 50. In the locking operation, the locking head 12 is first lowered onto the container 50 by a crane or other lifting apparatus (not shown) such as robotic arm or winch. The lifting apparatus uses pull straps (not shown) wrapped around or attached to the pull bars 17. The pulls straps may be made of variety of materials, but must be sufficiently strong to support the combined weight of the locking head 12 and the object to be conveyed or lifted. A crane hook (not shown) and cable may be used instead of pull bars 17 and pull straps.

As the locking head 12 is lowered, the engaging portion 74 of the grippers 16 contacts the deflecting groove 44 causing the grippers 16 to rotate inwards about their respective pivots 18. As the locking head 12 is lowered further, the gripper heads 72 rotates enough to clear the deflecting groove 44, while not rotating enough such that outer fasteners 22 are engaged. The grippers 16 are now in a retracted or inward position (not shown). When lowered past groove 44, gravity then urges the gripper heads 72 to swing outwards and into the engaging position wherein the engaging portion 74 engages the engaging groove 46 in the chamfer 48. Alternatively, a biasing element, for example, a tension spring, can be used to urge the gripper outwards. In this position the grippers 16 are “locked” with the engaging groove 46 (FIG. 8B). The locking head 12 and container 50, now engaged, can be raised by the lifting apparatus and moved to the desired location.

When at the desired location, the lifting apparatus then lowers the locking head 12 and container 50 onto the ground or surface of the unloading area. Using the lifting apparatus, the weight or load of the locking head 12 is released or a downward pressure is applied by the lifting apparatus, thereby applying a downward pressure, such as gravity, on the locking head 12 and the coupling 56 of the container 50. As seen in FIG. 8C, this downward pressure causes the lower chamfer 78 of the grippers 16 to contact the release surface 49 of the engaging groove 46. The downward pressure on the release surface 49 causes the grippers 16 to rotate inwards about their respective pivots 18 and into the released position. Once in the released position, the outer fasteners 22 releaseably engage and hold the grippers 16 in the released position. When the outer fasteners 22 are ball-plungers 28, the ball-plungers 28 engage the detent holes 30 in the upper portion of the grippers 16. The ball-plungers 28 hold the grippers 16 in position against the urging force applied by gravity and/or a biasing element. In the released position, the locking head 12 rests upon the top of the coupling 56.

With the grippers 16 held in the released position, the grippers 16 are clear of the grooves 44 and 46 and the locking head 12 is disengaged or “released”. The lifting apparatus may then be used to lift and remove the locking head 12 from the coupling 56 of the container 50 (FIG. 8D). When the locking head 12 is removed, the grippers 16 are still held in the released position by the outer fasteners 22. Prior to another lifting operation, the grippers 16 must be reset by moving the grippers 16 back to the engaging position. During the resetting operation, the force applied to the grippers 16 must be sufficient to disengage the grippers 16 from the outer fasteners 22, for example, to disengage the ball-plungers 28 from the detent holes 30. The resetting operation may be performed by various means including the use of robotic apparatus or the manual movement of the grippers 16 by a technician, or automatically or remotely by electrically induced release of a magnet or pneumatically or electrically operated mechanical release.

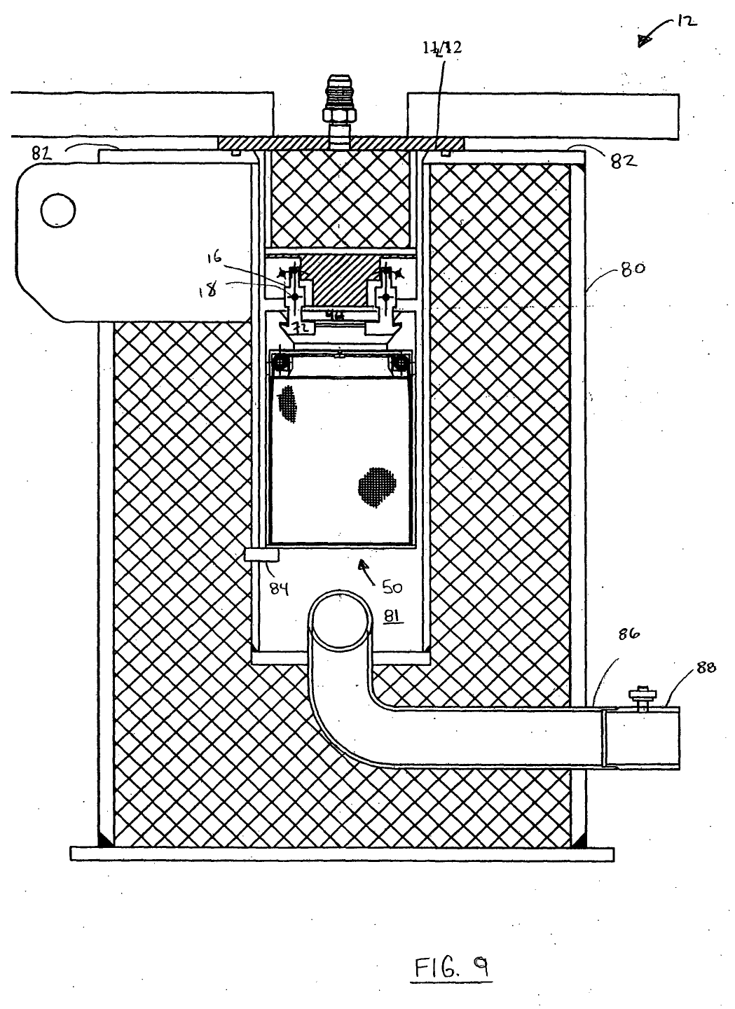

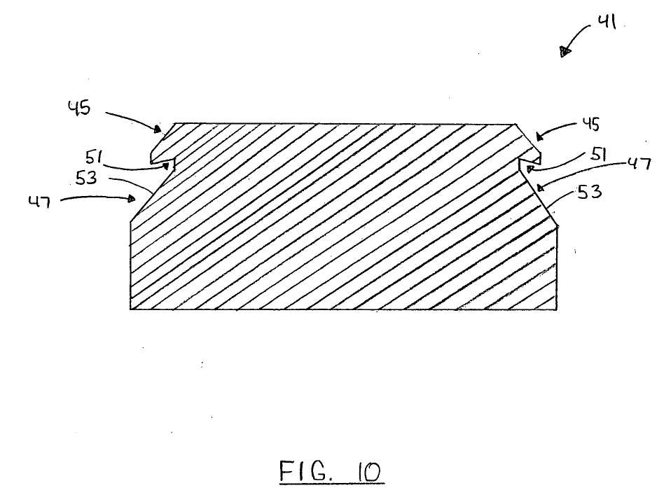

Referring now to FIG. 9, an exemplary application of the locking head 12 and container 50 will be discussed. The container 50 is received in a containment or shielding vessel 80. The container 50 is used to store hazardous material, for example, radioactive material. Other types of hazardous and non-hazardous material may be stored in the container 50. The containment vessel 80 is used to shield operators, technicians, and other personnel from the hazardous material. The containment vessel 80 defines a holding cavity 81 and has a top surface 82. The container 50 is supported in the vessel 80 by a ledge 84. An outlet pipe 86 having outlet adapter 88 is located at the bottom of the holding cavity 81.

In the locking operation, the locking head 12 is first lowered onto the container 50 by a crane or other lifting apparatus (not shown) using the pull bars 17 and pull straps (not shown). As the locking head 12 is lowered, the engaging portion 74 of the grippers 16 contacts the deflecting groove 44 causing the grippers 16 to rotate inwards about their respective pivots 18. As the locking head is lowered further, the gripper head 72 clears the deflecting groove 44 and continues lower until the stop surface 23 of the locking head 12 meets the top surface 82 of the containment vessel 80. This is the stop point created by the stop plate 23. The stop point prevents the operator of the lifting apparatus from lowering the locking head 12 too far and prematurely rotating the grippers 16 into the released position.

The grippers 16 are now in a retracted or inward position. At or near the stop point, gravity or biasing elements urge the gripper heads 72 outwards and into the engaging position wherein the engaging portion 74 engages the engaging groove 46 in the chamfer 48. In this position the grippers 16 are “locked” with the engaging groove 46 (FIG. 8B). The locking head 12 and container 50, now engaged, can be raised by the lifting apparatus and moved to the desired location, and the locking head 12 can be removed as discussed above.

The present invention may be used as an internal gripper, for example, for controllably gripping bottles or other containers from within for transport and release in a batch or continuous process. The present invention may be used with most objects having a groove, aperture or bore formed defined in the top thereof, for example, nuclear fuel assemblies and control rods.

In the embodiments described above, the locking head 12 is introduced into the cavity of a coupling that is attached to or is a part of the object to be conveyed or lifted, and the locking operation is accomplished by the grippers 16 extending or spreading outwards to engage behind a groove of the object to be lifted. In this manner, the locking head 12 functions as an internal gripper. However, the present invention may also be applied to external grippers that accomplish locking by extending or spreading the grippers 16 inwards to engage behind a groove on the exterior of the object to be lifted. This external groove may be part of a coupling that is attached to or is a part of the object to be conveyed or lifted, or may be an integral part of the object, for example, an external lip or indentation in the exterior surface of a barrel or drum.

Referring now to FIG. 10, a coupling 41 which may be engaged by an external gripper mechanism implemented according to the present invention will be described. The coupling 41 defines two concentric grooves, a deflecting groove 45 and an engaging groove 47 having a concentric notch or chamfer 51 and a release surface 53. The grooves 45 and 47 are tapered downwardly and outwardly in the direction of the base of the coupling 41. The deflecting groove 45 and the engaging groove 47 function in a similar manner to the grooves 44 and 46 discussed above. To grip the coupling 41, the orientation of the grippers must be reversed from that of the locking head 12 such that grippers are directed towards the grooves 45 and 47. The coupling 41 is circular in design, but a different shape, for example square or rectangular, may also be used if desired.

Although the present invention has been described with reference to illustrative embodiments, it is to be understood that the invention is not limited to these precise embodiments, and that various changes and modifications may be effected therein by one skilled in the art. All such changes and modifications are intention to be encompassed in the appended claims.

1. A gripper mechanism for conveying an object, comprising:
a housing;
a gripper member, said gripper member being pivotably attached to an end of said housing, said gripper member being pivotable about a pivot point between a first and second limit position, said pivot point located on said gripper member between a gripper head and a gripper tail; and
a first fastener on said housing for releasably securing said gripper member into said first limit position.

2. The gripper mechanism of claim 1, wherein said gripper member has one pivot point.

3. The gripper mechanism of claim 1, further comprising a second fastener on said housing for releasably securing said gripper member in said second limit position.

4. The gripper mechanism of claim 1, further comprising a plurality of gripper members and a plurality of corresponding first fasteners.

5. The gripper mechanism of claim 4, comprising two said gripper members.

6. The gripper mechanism of claim 4, comprising three said gripper members.

7. The gripper mechanism of claim 1, wherein said gripper members are pivotable about an axis perpendicular to the central axis of said housing.

8. The gripper mechanism of claim 6, wherein said gripper members are equally spaced about the lower end of said housing.

9. A gripper mechanism for a coupling having a recessed concentric engaging groove including a release surface, said gripper mechanism, comprising:
a housing;
a gripper member, said gripper member being pivotably attached to and spaced about an end of said housing, said gripper member being pivotable about a pivot point between a first and second limit position, said pivot point located on said gripper member between a gripper head and a gripper tail; and
a first fastener on said housing for releasably securing said gripper member into said first limit position.

10. The gripper mechanism of claim 9, wherein said gripper head includes an engaging portion having an upper chamfer, said engaging portion being adapted for engaging the engaging groove of the coupling.

11. The gripper mechanism of claim 9, wherein the coupling comprises a container.

12. The gripper mechanism of claim 10, wherein the angle of inclination of said upper chamfer corresponds to the angle of the first surface of the coupling.

13. The gripper mechanism of claim 12, wherein the coupling further includes a recessed concentric deflecting groove.

14. The gripper mechanism of claim 9, further comprising an second fastener on said housing for releasably securing said gripper member in said second limit position.

15. The gripper mechanism of claim 9, further comprising a plurality of gripper members and a plurality of corresponding first fasteners.

16. The gripper mechanism of claim 14, wherein a biasing element urges said gripper members into one of said first limiting position or said second limiting positions.

17. The gripper mechanism of claim 9, wherein said outer fasteners are ball-plungers.

18. The gripper mechanism of claim 9, wherein said outer fasteners are spring tension beveled pins.

19. The gripper mechanism of claim 9, wherein the engaging groove of the coupling is defined on the interior of the coupling.

20. The gripper mechanism of claim 9, wherein the engaging groove of the coupling is defined on the exterior of the coupling.

21. The gripper mechanism of claim 1, wherein said gripper head is heavier than said gripper tail.

22. The gripper mechanism of claim 1, further comprising a biasing member for urging said gripper head into said second limit position.

23. The gripper mechanism of claim 1, wherein said first fastener holds said gripper member in a release position.

24. The gripper mechanism of claim 21, wherein said first fastener holds said gripper member in a release position and gravity urges said gripper member to a grip position.

25. A gripper system comprising:
a gripper mechanism according to claim 11;
a vessel adapted to hold said container;
wherein said gripper mechanism has a stop surface and said vessel has a stop plate adapted to stop said stop surface at a point where said gripper members have engaged said engaging groove.
